(19) United States
(12) Patent Application Publication
(10) Pub. No.: US 2025/0086428 A1
(43) Pub. Date: Mar. 13, 2025

(54) METHOD AND SYSTEM FOR PREDICTING TARGET DESCRIPTOR VALUE OF TARGET OBJECT

(71) Applicant: Beijing Real Material Data Technology Development Co., Ltd., Beijing (CN)

(72) Inventors: Xiaodong XIANG, Danville, CA (US); Shaomeng XU, Kunming (CN)

(73) Assignee: Beijing Real Material Data Technology Development Co., Ltd., Beijing (CN)

(21) Appl. No.: 18/955,739

(22) Filed: Nov. 21, 2024

Related U.S. Application Data
(60) Provisional application No. 63/426,814, filed on Nov. 21, 2022.

(30) Foreign Application Priority Data
Nov. 21, 2023 (CN) 202311560382.9

(51) Int. Cl. G06N 3/045

(52) U.S. Cl. CPC G06N 3/045

(57) ABSTRACT

A method and a system for predicting a target descriptor value of a target object are provided. The method includes: obtaining m₀ groups of descriptors of a target object, where each group of descriptors includes at least N descriptors related to the target object; performing level-0 inference based on each of the m₀ groups of descriptors separately to obtain m₀ initial predicted values TD₀s corresponding to a target descriptor of the target object; and performing F levels of inference based on the m₀ TD₀s to obtain a final predicted value TD_{F} of the target descriptor.

### RELATED APPLICATIONS

This application claims the benefit of priority of Chinese application number 2023115603829, filed on Nov. 21, 2023, which claims the benefit of priority of U.S. provisional application No. 63/426,814, filed on Nov. 21, 2022, and the contents of the foregoing documents are incorporated herein by reference in entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of artificial intelligence technology, and in particular to a method and system for predicting a target descriptor value of a target object.

### BACKGROUND

In the related technology, a training system can train a neural network model, and a prediction system can predict the target descriptor values of a target object based on the neural network model.

The neural network model is a single-level inference network. In other words, when the prediction system obtains input information, the input information may be input into the single-level inference neural network model, and the target descriptor value corresponding to the target object is output through single-level inference of the neural network model.

However, the inventors of this disclosure have found that when the prediction system uses the above method to predict the target descriptor values, the accuracy of the predicted values based on the neural network model is low due to the suboptimal inference performance of the neural network model.

The content in the background section is only information known to the inventors and does not represent that such information had entered the public domain prior to the filing date of this disclosure, nor does it represent that it can be considered prior art of this disclosure.

### SUMMARY

The present disclosure provides a method and system for predicting a target descriptor value of a target object, to improve accuracy and reliability of the predicted target descriptor value.

In a first aspect, the present disclosure provides a method for predicting a target descriptor value of a target object, including: obtaining m₀ groups of descriptors of a target object, where each group of descriptors includes at least N descriptors related to the target object; performing level-0 inference based on each of the m₀ groups of descriptors separately to obtain m₀ initial predicted values TD₀s corresponding to a target descriptor of the target object; and performing F levels of inference based on the m₀ TD₀s to obtain a final predicted value TD_{F} of the target descriptor, where level-i inference in the F levels of inference includes: obtaining level-(i−1) predicted values TDᵢs of the target descriptor, where a quantity of the TDᵢ₋₁s is mᵢ₋₁ and the TDᵢ₋₁s are predicted values corresponding to the target descriptor and obtained through level-(i−1) inference, grouping the mᵢ₋₁ TDᵢ₋₁s into mᵢ groups according to a preset grouping relationship, and performing inference on the mᵢ groups of TDᵢ₋₁s separately to obtain mᵢ level-i predicted values TDᵢs of the target descriptor, where m₀, N, F, mᵢ₋₁, and mᵢ are all integers greater than or equal to 1, and i meets 1≤i≤F.

In a second aspect, the present disclosure provides a system for predicting a target descriptor value of a target object, including: at least one storage medium, storing at least one instruction set for predicting a target descriptor value of a target object; and at least one processor, communicatively connected to the at least one storage medium, where during operation, the at least one processor executes the at least one set of instructions to cause the system to at least: obtain m₀ groups of descriptors of a target object, where each group of descriptors includes at least N descriptors related to the target object, perform level-0 inference based on each of the m₀ groups of descriptors separately to obtain m₀ initial predicted values TD₀s corresponding to a target descriptor of the target object, and perform F levels of inference based on the m₀ TD₀s to obtain a final predicted value TD_{F} of the target descriptor, where level-i inference in the F levels of inference includes: obtaining level-(i−1) predicted values TDᵢ₋₁s of the target descriptor, where a quantity of the TDᵢ₋₁s is mᵢ₋₁ and the TDᵢ₋₁s are predicted values corresponding to the target descriptor and obtained through level-(i−1) inference, grouping the mᵢ₋₁ TDᵢ₋s into mᵢ groups according to a preset grouping relationship, and performing inference on the mᵢ groups of TDᵢ₋₁s separately to obtain mᵢ level-i predicted values TDᵢs of the target descriptor, where m₀, N, F, mᵢ₋₁, and mᵢ are all integers greater than or equal to 1, and i meets 1≤i≤F.

The present disclosure provides a method and system for predicting a target descriptor value of a target object. The method includes: obtaining m₀ groups of descriptors of a target object, where each group of descriptors includes at least N descriptors related to the target object; performing level-0 inference based on each of the m₀ groups of descriptors separately to obtain m₀ initial predicted values TD₀s corresponding to a target descriptor of the target object; and performing F-level inference based on the m₀ TD₀s to obtain a final predicted value TD_{F} of the target descriptor, where level-i inference in the F-level inference includes: obtaining level-(i−1) predicted values TDᵢ₋₁s of the target descriptor, where a quantity of the TDᵢ₋₁s is mᵢ₋₁ and the TDᵢ₋₁s are predicted values corresponding to the target descriptor and obtained through level-(i−1) inference, grouping the mᵢ₋₁ TDᵢ₋₁s into mᵢ groups according to a preset grouping relationship, and performing inference on the mᵢ groups of TDᵢ₋₁s separately to obtain mᵢ level-i predicted values TDᵢs of the target descriptor, where m₀, N, F, mᵢ₋₁, and mᵢ are all integers greater than or equal to 1, and i meets 1≤i≤F. In the embodiments, a prediction system uses multi-level inference from level-0 inference to level-F inference to deepen an inference process and improve reliability of inference. In addition, inference at each level of inference is parallel inference (such as parallel inference based on each group of descriptors in the level-0 inference), so that inference at the same level is mutually independent to avoid interference, thereby further improving the reliability of inference. Moreover, inference between levels is integrated inference, that is, an output of a previous level is an input of a next level (for example, an output of level-0 inference is an input of level-1 inference), so that inference at various levels is mutually related, and that the final predicted value TD_{F} with relatively high accuracy and reliability is finally obtained.

### BRIEF DESCRIPTION OF THE DRAWINGS

The accompanying drawings herein are incorporated into the disclosure and constitute a part of the disclosure. The accompanying drawings show some exemplary embodiments in accordance with the present disclosure and are used together with the disclosure to explain the principle of the present disclosure.

FIG. 1 is a schematic diagram of a structure of an ANN according to some exemplary embodiments of the present disclosure;

FIG. 2 is a schematic diagram of a structure of a CNN according to some exemplary embodiments of the present disclosure;

FIG. 3 is a schematic diagram of an application scenario of a method for predicting a target descriptor value of a target object according to some exemplary embodiments of the present disclosure;

FIG. 4 is a schematic diagram of a method for predicting a target descriptor value of a target object according to some exemplary embodiments of the present disclosure;

FIG. 5 is a schematic diagram of a method for obtaining m₀ groups of descriptors of a target object according to some exemplary embodiments of the present disclosure;

FIG. 6 is a schematic diagram of a principle of a genetic algorithm according to some exemplary embodiments of the present disclosure;

FIG. 7 is a schematic diagram of an effect of a genetic algorithm according to some exemplary embodiments of the present disclosure;

FIG. 8 is a schematic diagram of a structure of a target super network according to some exemplary embodiments of the present disclosure;

FIG. 9 is a schematic diagram of a principle of adversarial processing according to some exemplary embodiments of the present disclosure;

FIG. 10 is a schematic diagram of a method for performing F levels of inference based on m₀ TD₀s to obtain a final predicted value TD_{F} of a target descriptor according to some exemplary embodiments of the present disclosure;

FIG. 11 is a schematic diagram of a predictive model training method according to some exemplary embodiments of the present disclosure; and

FIG. 12 is a schematic diagram of a structure of an electronic device according to some exemplary embodiments of the present disclosure.

Embodiments of the present disclosure have been illustrated clearly in the foregoing drawings, and will be described in more detail hereinafter. These drawings and text descriptions are not intended to limit the scope of the present disclosure in any manner, but to illustrate the concept of the present disclosure to a person skilled in the art by referring to specific embodiments.

### DETAILED DESCRIPTION

Exemplary embodiments will be described in detail herein, with examples illustrated in the accompanying drawings. In the following description, when referring to the drawings, the same numbers in different drawings indicate the same or similar elements, unless otherwise noted. The embodiments described in the following exemplary embodiments do not represent all possible embodiments consistent with this disclosure. Instead, they are merely examples of devices and methods consistent with some aspects of the present disclosure as detailed in the appended claims.

It should be understood that in the embodiments of this disclosure, the terms “comprising” and “having,” as well as any variations thereof, are intended to cover inclusive but not exclusive inclusion. For example, a product or device that includes a series of components is not necessarily limited to those components explicitly listed, but may include other components not explicitly listed or components inherent to those products or devices.

In the embodiments of this disclosure, the term “and/or” describes an associative relationship between associated objects, indicating three possible relationships. For example, “A and/or B” can represent: A alone, both A and B, or B alone. The character “/” generally indicates an “or” relationship between the associated objects.

The term “multiple” in this disclosure refers to two or more, and other quantifiers are used in a similar manner.

The terms “first,” “second,” “third,” and so on are used to distinguish similar or related objects or entities and do not necessarily imply a specific order or sequence, unless otherwise indicated. It should be understood that these terms can be used interchangeably where appropriate, for example, in a sequence other than that illustrated or described in the embodiments of this disclosure.

The terms “unit/module” used in this disclosure refer to any known or later-developed hardware, software, firmware, artificial intelligence, fuzzy logic, or a combination of hardware and/or software code capable of performing functions associated with that element.

To help a reader understand the present disclosure, at least some of the terms used in the present disclosure are described as follows:

A descriptor is information describing a target object. For example, in a case where the target object is a target material, the descriptor may be information for describing properties of the target material, such as information for describing conductivity of the target material; in a case where the target object is a target speech, the descriptor may be an intent and/or volume or the like for describing the target speech; in a case where the target object is a target text, the descriptor may be characters or the like for describing the target text; or in a case where the target object is a target image, the descriptor may be a texture feature, a color feature, a pixel feature, a position feature, or the like for describing the target image.

A target descriptor value is a predicted value corresponding to a target descriptor. For example, in a case where the target object is a target material, the target descriptor value may be understood as a predicted value for predicting performance of the target material. For example, the predicted value may be conductivity or the like, which is not exhaustively illustrated herein.

A neural network (Neural Network, NN) is a complex network system formed by a large quantity of simple processing units (which may also be referred to as neurons) that are widely interconnected. It reflects many basic characteristics of human brain functions and is a highly complex nonlinear dynamic learning system. Neural networks include an artificial neural network (Artificial Neural Network, ANN) and a convolutional neural network (Convolutional Neural Network, CNN).

The ANN refers to a complex network structure formed by a large quantity of interconnected neurons. The ANN is a kind of abstraction, simplification, and simulation of an organizational structure and operation mechanism of a human brain. The ANN may be classified into a multi-layer ANN and a single-layer ANN. Each layer includes several neurons. The neurons are connected by directed arcs with variable weights. The network repeatedly learns and trains known information and gradually adjusts and changes weights of neuron connections to achieve an objective of processing information and simulating an input-output relationship.

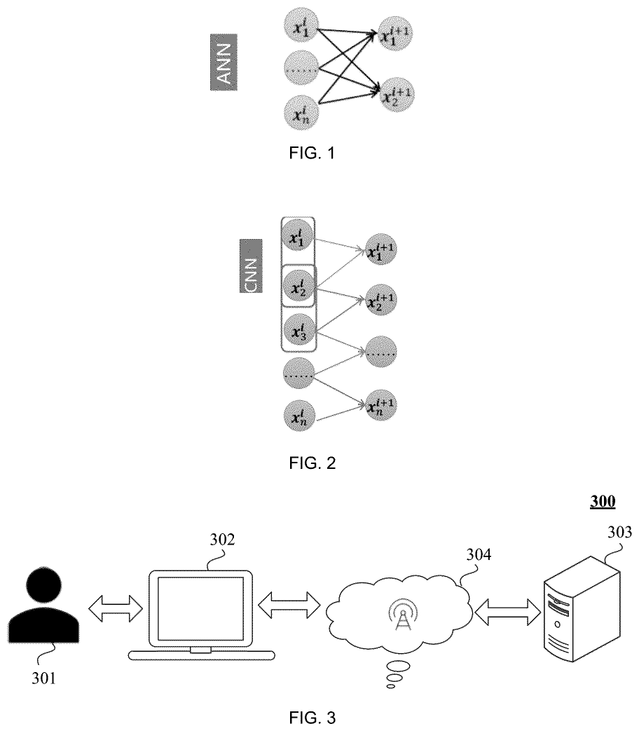

With reference to FIG. 1, it can be learned that neurons at each layer in the ANN are all connected to neurons at a previous layer. For example, as shown in FIG. 1, both x₁ⁱ⁺¹ and x₂ⁱ⁺¹ at an (i+1)^{th} layer are respectively connected to each of neurons x₁ⁱ to xₙⁱ at an i^{th} layer, where both i and n are integers greater than 0. Therefore, the ANN may also be referred to as a fully connected neural network.

Correspondingly, in a case where i is 1, if the target object is a target material, x is a descriptor of the target material, for example, may be specifically an element of the target material. In this case, a first layer is an input layer of the ANN. Because the ANN is a fully connected neural network, when the ANN is used as a network framework for model training, many parameters need to be optimized.

The CNN is a type of feedforward neural network (Feedforward Neural Network) that includes convolutional computing and has a deep structure. It is one of representative algorithms for deep learning (deep learning). The CNN is capable of representation learning (representation learning) and capable of performing shift-invariant classification (shift-invariant classification) on input information based on a hierarchical structure of the CNN. Therefore, the CNN is also referred to as a “shift-invariant artificial neural network (Shift-Invariant Artificial Neural Network, SIANN)”.

With reference to FIG. 2, it can be learned that neurons in the CNN have clear division of roles. A neuron at a next layer is locally connected to a neuron at a previous layer. As shown in FIG. 2, a neuron x₁ⁱ⁺¹ at an (i+1)^{th} layer is connected to neurons x₁ⁱ and x₂ⁱ at an i^{th} layer, a neuron x₁ⁱ⁺² at the (i+1)^{th} layer is connected to neurons x₂ⁱ and x₃ⁱ at the i^{th} layer, . . . , a neuron xₙⁱ⁺¹ at the (i+1)^{th} layer is connected to neurons xₙⁱ and xₙ₋₁ⁱ at the i^{th} layer (not shown in the figure).

Correspondingly, compared with model training using the ANN as a network framework, when model training is performed by using the CNN as a network framework, since weights are shared between neurons at each layer of the CNN, parameters that need to be optimized are reduced in comparison with those in the ANN.

In the related art, a prediction system may predict a target descriptor value based on a pre-trained neural network model, and the neural network model may be obtained by the prediction system through training or by other systems (such as a training system) through training. This is not limited herein.

For example, using the neural network model obtained by the training system through training as an example, the pre-trained neural network model is obtained by the training system through training based on sample data, and the sample data may be a sample descriptor. In other words, at a training stage of the neural network model, the training system may input the sample descriptor into an initial network model for single-level inference (the ANN or the CNN) to predict the sample data based on the initial network model, and output a prediction result (that is, a predicted target descriptor value). The prediction system compares the prediction result with a pre-marked real result (that is, a real target descriptor value) to obtain a comparison result, and iteratively updates parameters of the initial network model based on the comparison result, thereby obtaining a trained neural network model.

Correspondingly, the training system may transmit the trained neural network model to the prediction system, or the prediction system may invoke the trained neural network model from the training system in presence of a prediction requirement, to perform prediction based on the trained neural network model. For example, at an application stage, the prediction system inputs prediction data that needs to be predicted into the trained neural network model and outputs the prediction result.

It should be noted that content of the related art is only information known to the inventor personally, and neither represents that the information has entered the public domain before the filing date of the present disclosure, nor represents that it can become the prior art of the present disclosure.

However, because the trained neural network model is a single-level inference network model, in a case that the prediction system uses this method to predict the target descriptor value of the target object at the application stage, there may be a disadvantage of low accuracy.

To avoid the foregoing technical problem, the present disclosure provides a technical conception obtained through creative labor: A prediction system predicts a target descriptor value of a target object by means of multi-level inference, and inference at a same level is parallel inference, that is, inference at the same level is mutually independent, but inference between adjacent levels is integrated inference, that is, one or more inference results of inference at a previous level are input information of inference at a next level, and so on, until a final predicted value of the target descriptor is obtained through inference at a last level.

Before an implementation principle of a method for predicting a target descriptor value of a target object in the present disclosure is described, an application scenario of the method for predicting a target descriptor value of a target object in the present disclosure is first described exemplarily to deepen the reader's understanding of the method for predicting a target descriptor value of a target object in the present disclosure.

FIG. 3 is a schematic diagram of an application scenario of a method for predicting a target descriptor value of a target object according to some exemplary embodiments of the present disclosure. The method for predicting a target descriptor value of a target object in the present disclosure may be applied to a system 300 for predicting a target descriptor value of a target object as shown in FIG. 3. As shown in FIG. 3, the system 300 may include a target user 301, a client 302, a server 303, and a network 304.

The target user 301 may be a user that triggers the system 300 to predict the target descriptor value of the target object.

The client 302 may be a device that responds to a prediction requirement of the target user 302. In other words, the method for predicting a target descriptor value of a target object may be performed on the client 302. In this case, the client 302 may store data or instructions for performing the method for predicting a target descriptor value of a target object as described in this disclosure, and may execute or may be configured to execute the data or instructions. In some embodiments, the client 302 may include a hardware device with a data information processing function and a necessary program required to drive the hardware device to work.

As shown in FIG. 3, the client 302 may be communicatively connected to the server 303. The server 303 may be communicatively connected to one client 302, or may be communicatively connected to a plurality of clients 302. In some embodiments, the client 302 may interact with the server 303 through the network 304 to receive or send messages or the like.

In some embodiments, the client 302 may include a mobile device, a tablet computer, a notebook computer, a built-in device in a motor vehicle, or the like, or any combination thereof. In some embodiments, the mobile device may include a smart home device, a smart mobile device, a virtual reality device, an augmented reality device, or the like, or any combination thereof. In some embodiments, the smart home device may include a smart television, a desktop computer, or the like, or any combination thereof. In some embodiments, the smart mobile device may include a smartphone, a personal digital assistant, a game console, a navigation device, or the like, or any combination thereof. In some embodiments, the built-in device in the motor vehicle may include a vehicle-mounted computer, a vehicle-mounted television, or the like.

In some embodiments, one or more applications (APP) may be mounted on the client 302. The APP can provide the target user 301 with an ability and an interface to interact with the outside world through the network 304. The APP includes but is not limited to a web browser APP program, a search APP program, a chat APP program, a shopping APP program, a video APP program, a financial management APP program, an instant messaging tool, an e-mail client, social platform software, or the like.

The server 303 may be a server that provides various services, such as a backend server that provides support for user data sets and account login information corresponding to a plurality of accounts collected on the client 302, and text retrieval of the plurality of accounts.

In some embodiments, the method for predicting a target descriptor value of a target object may be performed on the server 303. In this case, the server 303 may store data or instructions for performing the method for predicting a target descriptor value of a target object as described in this disclosure, and may execute or may be configured to execute the data or instructions.

In some embodiments, the server 303 may include a hardware device with a data information processing function and a necessary program required to drive the hardware device to work. Similarly, the server 303 may be communicatively connected to one client 303, and receive data sent by the client 303, or may be communicatively connected to a plurality of clients 303, and receive data sent by each client 303.

The network 304 is a medium for providing a communication connection between the client 302 and the server 303. The network 304 can facilitate exchange of information or data. As shown in FIG. 3, the client 302 and the server 303 may be connected to the network 304 respectively, and transmit information or data to each other through the network 304.

In some embodiments, the network 304 may be any type of wired or wireless network, or a combination thereof. For example, the network 304 may include a cable network, a wired network, an optical fiber network, a telecommunication network, an intranet, the Internet, a local area network (Local Area Network, LAN), a wide area network (Wide Area Network, WAN), a wireless local area network (Wireless Local Area Network, WLAN), a metropolitan area network (Metropolitan Area Network, MAN), a public switched telephone network (Public Switched Telephone Network, PSTN), a Bluetooth network™, a short-range wireless network (ZigBee™), a near field communication (Near Field Communication, NFC) network, or a similar network.

In some embodiments, the network 304 may include one or more network access points. For example, the network 304 may include a wired or wireless network access point, such as a base station or an Internet exchange point, through which one or more components of the client 302 and the server 303 may connect to the network 304 to exchange data or information.

It should be understood that quantities of clients 302, servers 303, and networks 304 in FIG. 3 are merely illustrative. Depending on implementation requirements, there may be any quantities of clients 302, servers 303, and networks 304. In addition, the method for predicting a target descriptor value of a target object according to the present disclosure may be performed entirely on the client 302, or may be performed entirely on the server 303, or may be performed partially on the client 302 and partially on the server 303.

In other words, FIG. 3 and the foregoing description of FIG. 3 are only used to exemplarily describe application scenarios to which the method for predicting a target descriptor value of a target object in the present disclosure may be applicable, and cannot be understood as a limitation on the application scenarios.

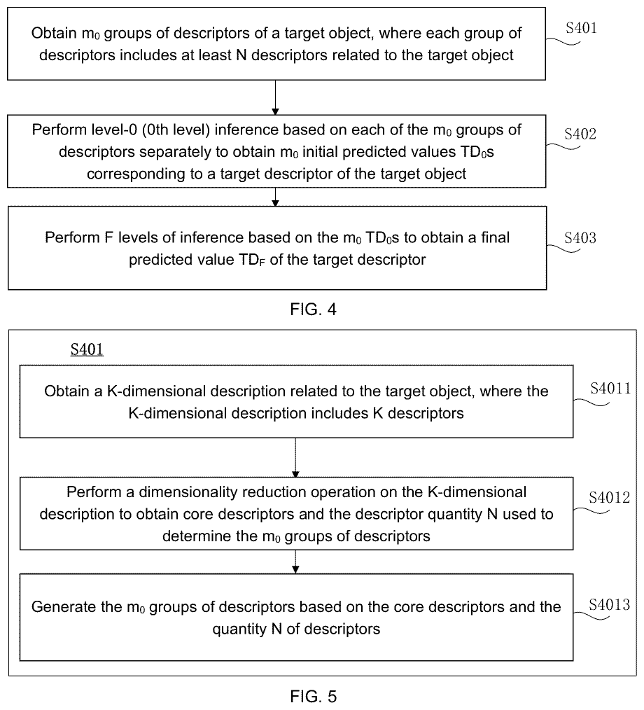

FIG. 4 is a schematic diagram of a method for predicting a target descriptor value of a target object according to some exemplary embodiments of the present disclosure. As shown in FIG. 4, the method includes the following steps.
S401: Obtain m₀ groups of descriptors of a target object, where each group of descriptors includes at least N descriptors related to the target object, where m₀ and N are integers greater than 1.

Exemplarily, this embodiment may be performed by a system for predicting a target descriptor value of a target object (hereinafter referred to as a prediction system). The prediction system may be a server (such as a cloud server or a local server), a terminal device, a processor, a chip, or the like, which is not limited in this embodiment.

For example, in a case that the method for predicting a target descriptor value of a target object in this embodiment is applied to the application scenario shown in FIG. 3, it can be learned from FIG. 3 and the foregoing description of FIG. 3 that the prediction system may be the client 302 shown in FIG. 3, or the server 303 shown in FIG. 3, or a combination of the client 302 and the server 303 shown in FIG. 3.

A manner of obtaining m₀ groups of descriptors by the prediction system is not limited in this embodiment. For example, with reference to the application scenario shown in FIG. 3, in a case that the prediction system is the client 302, the prediction system may receive m₀ groups of descriptors provided by the target user 301. In another example, in a case that the prediction system is the server 303, the prediction system may receive m₀ groups of descriptors provided by the client 302.

Quantities and/or content of descriptors in any two groups of descriptors obtained by the prediction system may be partially the same, completely the same, or completely different.

For example, the m₀ groups of descriptors include a first group of descriptors and a second group of descriptors, where the first group of descriptors includes N descriptors, the second group of descriptors includes N descriptors, and the N descriptors in the first group of descriptors may be completely the same as, partially the same as, or completely different from the N descriptors in the second group of descriptors.

In another example, the m₀ groups of descriptors include a first group of descriptors and a second group of descriptors, where the first group of descriptors includes N descriptors, the second group of descriptors includes N+n (n is an integer greater than 1) descriptors, and the N+n descriptors in the second group of descriptors may include the N descriptors in the first group of descriptors, or the N+n descriptors in the second group of descriptors may include a part of the N descriptors in the first group of descriptors, or the N+n descriptors in the second group of descriptors may have no common descriptors with the N descriptors in the first group of descriptors. It should be noted that, considering validity and reliability of prediction, in the m₀ groups of descriptors, descriptors in different descriptor groups are at least partially different.

In a possible technical solution, the target object may be one of a target material, a target speech, a target text, and a target image.

Exemplarily, with reference to the foregoing analysis, it can be learned that the method for predicting a target descriptor value of a target object in this embodiment of the present disclosure may be applied to different application scenarios. For different application scenarios, the target object may be different content.

For example, in a scenario in which the prediction system predicts related parameters of a material, the target object may be the target material, such as a material that the prediction system is about to predict; or in another example, in a scenario in which the prediction system performs speech prediction, the target object may be the target speech, such as a conversation audio of a user that the prediction system is about to predict, or the like, which is not exhaustively illustrated herein.

In a possible technical solution, as shown in FIG. 5, S401 may include the following steps.
S4011: Obtain a K-dimensional description related to the target object, where the K-dimensional description includes K descriptors, where K is an integer greater than 1.

Similarly, the K descriptors obtained by the prediction system and a value of K are not limited in this embodiment, and may be determined by the prediction system based on a requirement, a historical record, an experiment, or the like.

In addition, with reference to the foregoing analysis, it can be learned that the method for predicting a target descriptor value of a target object in the present disclosure may be applied to different scenarios, and the value of K in different scenarios may be different. For example, the value of K in a scenario of material prediction may be different from the value of K in a scenario of audio prediction.

In a possible technical solution, assuming that the target object is the target material, a quantity of descriptors may be determined by the prediction system based on 22 element properties in the related art, or the prediction system may extend 22 element properties based on physical properties of the elements to obtain extended element properties, and the extended element properties are more than 22 element properties, such as 53 element properties. Correspondingly, the prediction system may determine the quantity K of descriptors based on the extended element properties (such as 53 element properties).

The element properties may include: atomic number, group number, period number, enthalpy of melting, thermal conductivity, heat of vaporization, melting point, boiling point, and the like, which are not exhaustively illustrated herein.

An implementation of determining the quantity K of descriptors by the prediction system based on the extended element properties is not limited in this embodiment. Exemplarily, the prediction system may determine the quantity K of descriptors based on element distribution information (such as a ratio between elements), electronic structure information (such as a ratio of a quantity of valence electrons of an element to a total quantity of valence electrons), ionic compound properties (such as electron gain and loss properties between different elements), statistical information of the element properties, and the like of the target material.

The statistical information of the element properties may be values corresponding to the element properties and obtained by the prediction system through calculation based on different statistical methods. The statistical methods include: minimum value, maximum value, and range size; weighted minimum value, maximum value, and range size after weighted sorting; (weighted) minimum value, maximum value, range size, and mean value of an absolute percentage; and the like.
S4012: Perform a dimensionality reduction operation on the K-dimensional description to obtain core descriptors and the descriptor quantity N used to determine the m₀ groups of descriptors.

The descriptor quantity N refers to a quantity of descriptors among the K descriptors which keeps both accuracy of the dimensionality reduction operation and a quantity of descriptors participating in the dimensionality reduction operation approximately unchanged.

The core descriptor is a descriptor whose occurrence frequency in participating in the dimensionality reduction operation meets a preset condition among the K descriptors, and the preset condition is that a difference between a minimum occurrence frequency of the core descriptor among the core descriptors and a maximum occurrence frequency of a non-core descriptor is greater than a preset difference threshold.

Similarly, the preset difference threshold is not limited in this embodiment, for example, may be determined by the prediction system based on a requirement, a historical record, an experiment, or the like.

Exemplarily, the dimensionality reduction operation may be understood as: when the prediction system obtains input variables, finding new variables with smaller dimensions, where each variable is a combination of input variables, including information substantially the same as the input variables. Correspondingly, in this embodiment, the input variables may be understood as the K-dimensional description, and when the prediction system obtains the K-dimensional description, the prediction system finds new variables with smaller dimensions than the K-dimensional description, thereby obtaining the core descriptors and the quantity N of descriptors.

An algorithm used by the prediction system to perform the dimensionality reduction operation is not limited in this embodiment. For example, the algorithm used by the prediction system to perform the dimensionality reduction operation includes but is not limited to: independent component analysis (Independent Component Analysis, ICA), principal component analysis (PCA), factor analysis (FA), linear discriminant analysis (LDA), locally linear embedding (LLE), or a genetic algorithm (GA).

In other words, a purpose of performing the dimensionality reduction operation by the prediction system is to obtain content in two dimensions. Content in one dimension is: relatively, if the prediction system continues to use the dimensionality reduction operation, it is difficult for the prediction system to further reduce the quantity of descriptors, and accuracy of the dimensionality reduction operation basically remains unchanged. Correspondingly, the quantity of descriptors in this case is the quantity N of descriptors.

Content in the other dimension is: when the prediction system performs the dimensionality reduction operation based on the K descriptors, the specific number of times each descriptor is used may be different. For example, some descriptors are used by the prediction system for the dimensionality reduction operation for more times, and some descriptors are used by the prediction system for the dimensionality reduction operation for fewer times. The number of times a descriptor appears in the dimensionality reduction operation may be understood as an occurrence frequency. The more times the descriptor appears, the higher the occurrence frequency, or the fewer times the descriptor appears, the lower the occurrence frequency. Correspondingly, the prediction system may sort, in descending order, occurrence frequencies of the descriptors participating in the dimensionality reduction operation. If a difference between two adjacent occurrence frequencies is large, for example, greater than the preset difference threshold, a descriptor with a higher occurrence frequency in the two adjacent occurrence frequencies may be determined as a core descriptor with a lowest occurrence frequency, that is, the descriptor with the higher occurrence frequency in the two adjacent occurrence frequencies is determined as a core descriptor, and a descriptor with an occurrence frequency higher than the higher occurrence frequency in the two adjacent occurrence frequencies, among the descriptors participating in the dimensionality reduction operation, is determined as a core descriptor.

It should be understood that the sorting in descending order in the foregoing example is only an example for description. In another possible technical solution, the prediction system may also sort occurrence frequencies in ascending order. For an implementation principle thereof, refer to the foregoing example. Details are not described herein.

With reference to the foregoing analysis, it can be learned that the quantity K of descriptors may be determined by the prediction system based on the extended element properties. For example, if the quantity K of descriptors may be 909, that is, the quantity of descriptors used to describe the target object may be 909, the prediction system may determine the core descriptors from the 909 descriptors and the quantity N of descriptors in the m₀ groups of descriptors based on the dimensionality reduction operation.
S4013: Generate the m₀ groups of descriptors based on the core descriptors and the quantity N of descriptors.

With reference to the core descriptors and the quantity N of descriptors, it can be learned that the core descriptors and the quantity N of descriptors are descriptor information that keeps accuracy and stability of the prediction system in the dimensionality reduction operation approximately unchanged. Therefore, the descriptors in the m₀ groups of descriptors relatively have characteristics of the core descriptors and the N descriptors.

A manner of generating the m₀ groups of descriptors by the prediction system is not limited in this embodiment. Exemplarily, the prediction system may randomly select descriptors from the K descriptors based on the core descriptors and the quantity of descriptors, and generate the m₀ groups of descriptors based on the randomly selected descriptors.

For example, the prediction system may randomly select a quantity of descriptors from the K descriptors, and the selected descriptors include core descriptors. If there is a plurality of core descriptors, the selected descriptors may include at least some of the core descriptors. Relatively, to achieve high validity and reliability of inference of the prediction system, the selected descriptors include all the core descriptors.

In another example, the prediction system may randomly select a quantity of descriptors from the K descriptors based on a preset selection policy, and the selected descriptors include core descriptors. The selection policy may be that the prediction system labels non-core descriptors among the K descriptors, and starting from a first labeled non-core descriptor, selects other non-core descriptors at intervals of a preset quantity of labels, where the preset quantity may be determined based on a total quantity to be selected and a quantity of core descriptors to be selected. Certainly, the selection by the prediction system may also start from non-core descriptors with other labels. This is not limited in this embodiment.

Likewise, if there is a plurality of core descriptors, the selected descriptors may include at least some of the core descriptors. Relatively, to achieve high validity and reliability of inference of the prediction system, the selected descriptors include all the core descriptors.

In a possible technical solution, the quantity of core descriptors is L; in the m₀ groups of descriptors: L core descriptors in each group of descriptors are the same; and N-L non-core descriptors in each group of descriptors are randomly obtained from the K descriptors, and the N-L non-core descriptors in each group of descriptors are not repeated.

Exemplarily, for any two groups of descriptors in the m₀ groups of descriptors, such as a first group of descriptors and a second group of descriptors, the first group of descriptors includes L core descriptors, the second group of descriptors also includes L core descriptors, and the L descriptors in the first group of descriptors are the L core descriptors in the second group of descriptors. In addition, the first group of descriptors includes N-L non-core descriptors, and the second group of descriptors also includes N-L non-core descriptors, but the N-L non-core descriptors in the first group of descriptors and the N-L non-core descriptors in the second group of descriptors are different descriptors.

With reference to the foregoing analysis, it can be learned that the core descriptors and the quantity N of descriptors may be determined by the prediction system by performing the dimensionality reduction operation, and the dimensionality reduction operation may be implemented by the prediction system by using the genetic algorithm. Correspondingly, the core descriptors, the quantity of core descriptors, and the quantity N of descriptors may be predetermined by the prediction system. For example, a training system may determine the core descriptors, the quantity of core descriptors, and the quantity N of descriptors based on the genetic algorithm, and transmit the core descriptors, the quantity of core descriptors, and the quantity N of descriptors to the prediction system; or the core descriptors, the quantity of core descriptors, and the quantity N of descriptors may be determined by the prediction system based on the genetic algorithm.

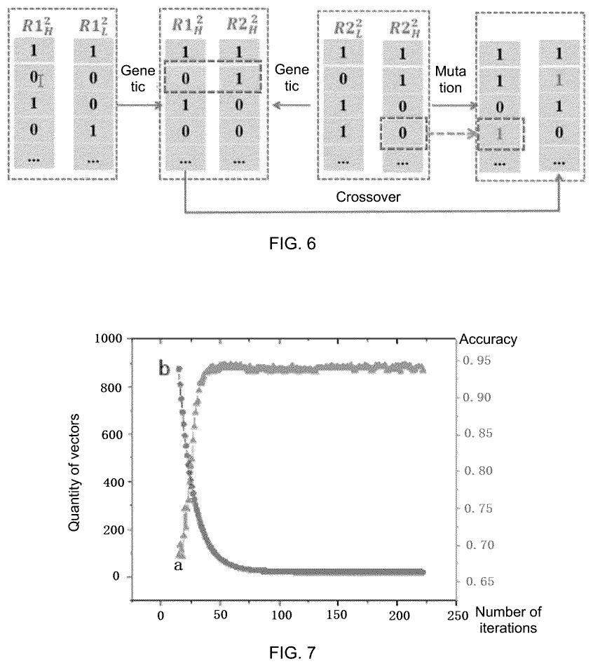

Exemplarily, sample data may be a sample descriptor. For understanding of the sample descriptor, refer to the description of the target descriptor. For example, a quantity of sample descriptors is also 909. Details are not described herein. Now, with reference to FIG. 6, and assuming that the quantity of sample descriptors is 909, and that the prediction system determines the core descriptors, the quantity of core descriptors, and the quantity N of descriptors based on the genetic algorithm, the implementation principle is described as follows:

As shown in FIG. 6, the prediction system generates a plurality of (for example, one thousand) vectors based on 909 descriptors. In any vector, a descriptor selected to participate in the genetic algorithm is represented by 1, and a descriptor not selected is represented by 0. When the prediction system runs the genetic algorithm (such as “Genetic” shown in FIG. 6), the prediction system may first randomly input two vectors (such as “R1_{H}²” and “R1_{L}²” shown in FIG. 6) into a preset initial network model to obtain prediction results corresponding to the two vectors, and select a vector (such as “R1_{H}²” shown in FIG. 6) with a relatively good prediction effect from the two vectors; then randomly input two vectors (such as “R2_{H}²” and “R2_{L}²” shown in FIG. 6) that are not repeated with the previous selection into the initial network model to obtain a vector (such as “R2_{H}²” shown in FIG. 6) with a relatively good prediction effect; then perform crossover and mutation operations (such as “crossover” and “mutation” shown in FIG. 6) on the vector R1_{H}² and the vector R2_{H}² to obtain vectors after the crossover and mutation; and then input the mutated vectors and randomly selected non-repeated vectors into the initial network model to obtain a vector with a relatively good prediction effect, and so on, until the core descriptors, the quantity of core descriptors, and the quantity N of descriptors are obtained.

As shown in FIG. 6, the prediction system may perform a mutation operation on the vector R2_{H}²; for example, mutate a fourth value in the vector R2_{H}² from 0 to 1. The prediction system may also perform a crossover operation on R1_{H}² based on the vector R2_{H}², for example, change a second value in the vector R1_{H}² from 0 to 1 to be the same as a second value in the vector R2_{H}².

It should be noted that when the prediction system performs the crossover and mutation operations, the prediction system may select one value in the vector or select a plurality of values to implement the operation. In the foregoing example, only one value is used as an example for description, but this cannot be understood as a limitation on the crossover and mutation operations in this embodiment.

Correspondingly, with reference to FIG. 7, a horizontal coordinate is the number of iterations, and a vertical coordinate includes content in two dimensions, where content in one dimension is a quantity of vectors generated based on sample data, which may be one thousand shown in FIG. 7, and content in the other dimension is accuracy of a prediction result. FIG. 7 includes two curves, where one curve is a curve of a dimension of a descriptor (“b” shown in FIG. 7), and the other curve is a curve of accuracy (“a” shown in FIG. 7).

From FIG. 7, it can be learned that in a scenario in which the prediction system performs iterations based on the genetic algorithm, as the number of iterations increases, when the number of iterations reaches a threshold (approximately 50 shown in FIG. 7), the accuracy and the quantity of descriptors basically remain unchanged. For example, the accuracy remains approximately 0.95, and the quantity of descriptors remains approximately 20.

Therefore, the quantity N of descriptors may be understood as the quantity of descriptors in the genetic algorithm when descriptor dimensions are basically stable and no longer decrease, and the accuracy is also basically stable and does not decrease. The core descriptor may be determined based on a statistical frequency of each descriptor participating in the genetic algorithm. For example, the prediction system determines the occurrence frequency of each descriptor participating in the genetic algorithm, that is, the number of times the descriptor appears in the genetic algorithm, and determines a plurality of descriptors with higher occurrence frequencies from all occurrence frequencies as core descriptors. For example, top L descriptors with the highest occurrence frequency are used as core descriptors, and a difference between the lowest occurrence frequency in the core descriptors and the highest occurrence frequency in the non-core descriptors is large. For example, there is a cliff-like drop of the occurrence frequency of each descriptor due to the difference between the lowest occurrence frequency and the highest occurrence frequency.

Correspondingly, in a possible technical solution, N is 20 and L is 5. For example, for any group of descriptors in the m₀ groups of descriptors, the group of descriptors includes 20 descriptors, and the 20 descriptors include 5 core descriptors and 15 non-core descriptors.

It should be noted that the foregoing examples illustrate that the prediction system may implement the dimensionality reduction operation in different manners. For dimensionality reduction operations in different manners, the quantity of core descriptors and the quantity of descriptors may be different. Therefore, “N is 20 and L is 5” mentioned above is only used to illustrate possible values of N and L, and cannot be understood as a limitation on the values of N and L.
S402: Perform level-0 (0th level) inference based on each of the m₀ groups of descriptors separately to obtain m₀ initial predicted values TD₀s corresponding to a target descriptor of the target object.

Exemplarily, the prediction system performs level-0 parallel inference based on the m₀ groups of descriptors to obtain an initial predicted value TD₀ corresponding to each group of descriptors. For example, in a case that the m₀ groups of descriptors include the first group of descriptors and the second group of descriptors, the prediction system performs inference on the first group of descriptors and the second group of descriptors separately, where inference performed on the first group of descriptors and inference performed on the second group of descriptors are parallel and do not affect each other. In this way, an initial predicted value based on the inference on the first group of descriptors and an initial predicted value based on the inference on the second group of descriptors are obtained. Because there is no mutual interference when inference is performed on each group of descriptors in the inference process of the prediction system, the technical solution of this embodiment of the present disclosure can achieve high reliability and accuracy of inference, that is, make the obtained initial predicted values TD₀s accurate and reliable.

In addition, based on the foregoing analysis, it can be learned that, because the m₀ groups of descriptors are determined based on the core descriptors and the quantity N of descriptors, the core descriptors and the quantity N of descriptors can meet accuracy and stability of the dimensionality reduction operation of the prediction system. Thanks to this characteristic, when inference is performed based on the m₀ groups of descriptors to obtain the initial predicted values TD₀s, the predicted values TD₀s can have high validity and reliability.

In a possible technical solution, neural networks from level 0 to level F constitute a target super network, each neural network in the target super network is a network node in the target super network, a quantity of network nodes decreases progressively from level 0 to level F, and each neural network is a pre-trained sub-neural network.

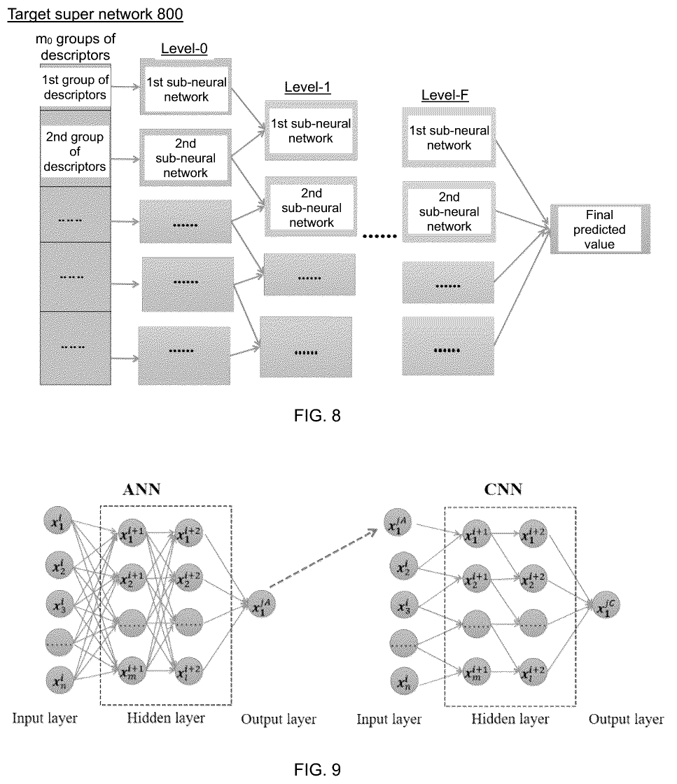

Exemplarily, as shown in FIG. 8, the target super network 800 includes a plurality of levels of neural networks, such as neural networks from level 0 to level F. Each neural network level may include one or more neural networks. For example, neural networks from level 0 to level F−1 ((F−1) th) all include a plurality of neural networks, neural network level F includes one neural network, and one neural network is one network node. In other words, each neural network level may include a plurality of network nodes. From level 0 to level F, a quantity of network nodes at each level gradually decreases.

For any neural network level, each network node in a neural network at this level may be a pre-trained sub-neural network, and the sub-neural network is used to output a predicted value based on input information.

For example, with reference to the foregoing examples, and using a level-0 neural network as an example, the level-0 neural network includes a first sub-neural network and a second sub-neural network, the m₀ groups of descriptors include the first group of descriptors and the second group of descriptors, an input of the first sub-neural network is the first group of descriptors, and an input of the second sub-neural network is the second group of descriptors. Correspondingly, because the first sub-neural network and the second sub-neural network are pre-trained sub-neural networks, the first sub-neural network can perform prediction based on the first group of descriptors to obtain an initial predicted value corresponding to the first group of descriptors, and the second sub-neural network can perform prediction based on the second group of descriptors to obtain an initial predicted value corresponding to the second group of descriptors.

A manner of decreasing of the quantity of network nodes at each level is not limited in this embodiment. For example, the quantity of network nodes at each level decreases regularly, such as decreasing in sequence by a fixed quantity, that is, a difference between a quantity of network nodes at level 0 and a quantity of network nodes at level 1 is the same as a difference between the quantity of network nodes at level 1 and a quantity of network nodes at level 2. In another example, the quantity of network nodes at each level decreases irregularly, such as decreasing by an unfixed quantity.

In a possible technical solution, there is one level-F neural network, with a TDF−1 as an input and the final predicted value TD_{F} of the target descriptor as an output.

Exemplarily, a quantity of level-F neural nodes may be 1. In other words, from level 0 to level F, the quantity of network nodes at each level decreases until it decreases to one network node at level F.

In a possible technical solution, each sub-neural network in the target super network is a pre-trained neural network, or a combination of two pre-trained neural networks, where
in a case that each sub-neural network in the target super network is a pre-trained neural network, the pre-trained neural network is an ANN or a CNN; or in a case that each sub-neural network in the target super network is a combination of two pre-trained neural networks, the combination of the two neural networks is a combination of an ANN and a CNN.

Exemplarily, any one of the network nodes may be one neural network or two neural networks. In a case that a network node is one neural network, the network node may be an ANN or a CNN. In a case that a network node is two neural networks, the network node may be a combination of an ANN and a CNN, that is, the network node includes both the ANN and the CNN.

For example, with reference to the foregoing example, and assuming that the m₀ groups of descriptors include the first group of descriptors, and that the level-0 neural network includes the first sub-neural network, and that the input of the first sub-neural network is the first group of descriptors, the first sub-neural network may be an ANN or a CNN.

In a case that the first sub-neural network is an ANN, the first sub-neural network ANN performs inference based on the first group of descriptors to obtain an initial predicted value corresponding to the target descriptor. In a case that the first sub-neural network is a CNN, the first sub-neural network CNN performs inference based on the first group of descriptors to obtain an initial predicted value corresponding to the target descriptor.

In a case that the first sub-neural network includes an ANN and a CNN, the first sub-neural network ANN performs inference based on the first group of descriptors to obtain an initial predicted value corresponding to the target descriptor (for distinction, the initial predicted value is referred to as a first initial predicted value), and the first sub-neural network CNN performs inference based on the first group of descriptors and the first initial predicted value to obtain an initial predicted value corresponding to the target descriptor (similarly, for distinction, the initial predicted value is referred to as a second initial predicted value).

Exemplarily, with reference to FIG. 9, a neural network includes both an ANN and a CNN, both the ANN and the CNN include an input layer (input layer), a hidden layer (hidden layer), and an output layer (output layout), and both the ANN and the CNN include two neuron layers.

At the hidden layers of the ANN and the CNN, a quantity of neurons at a first layer is m, and a quantity of neurons at a second layer is l, where m and l are integers greater than 1. At the hidden layers of both the ANN and the CNN, the first neuron layer may be marked as x₁ⁱ⁺¹, x₂ⁱ⁺¹, . . . , xₙⁱ⁺¹, and the second neuron layer may be marked as x₁ⁱ⁺², x₂ⁱ⁺², . . . , xₗⁱ⁺², where i is an integer greater than or equal to 0.

As shown in FIG. 9, an input of the ANN includes x₁ⁱ, x₂ⁱ, x₃ⁱ, . . . , xₙⁱ, where n is an integer greater than 1. In addition, with reference to the foregoing description of characteristics of the ANN, an input of each neuron of the ANN is a full input. In other words, as shown in FIG. 9, an input of each neuron of x₁ⁱ⁺¹, x₂ⁱ⁺¹, . . . , xₘⁱ⁺¹ includes x₁ⁱ, x₂ⁱ, x₃ⁱ, . . . , xₙⁱ, an input of each neuron at the second neuron layer of the ANN is an output of each neuron at the first neuron layer of the ANN, and an output of the ANN is x₁^{jA}.

Correspondingly, the prediction system may perform adversarial processing based on the output x₁^{jA} of the ANN. In addition, with reference to the foregoing description of characteristics of the CNN, as shown in FIG. 9, in the CNN, an input of x₁ⁱ⁺¹ is x₁^{jA} and x₂ⁱ, an input of x₂ⁱ⁺¹ is x₂ⁱ and x₃ⁱ, an input of x₁ⁱ⁺² is x₁ⁱ⁺¹, an input of x₂ⁱ⁺² is x₁ⁱ⁺¹ and x₂ⁱ⁺¹, and so on. Details are not exhaustively illustrated herein.

As shown in FIG. 9, the prediction system performs adversarial processing based on the ANN and the CNN at a neural network level, thereby obtaining an output x₁^{JC} of the neural network at the level.

It should be noted that the foregoing example is only an example for illustrating that the prediction system uses an output of the ANN as an input of the CNN for adversarial processing, and cannot be understood as a limitation on the adversarial processing of the prediction system. For example, in another possible technical solution, the prediction system may use an output of the CNN as an input of the ANN for adversarial processing. For a specific implementation principle thereof, refer to the foregoing example. Details are not described herein.

In a possible technical solution, S402 may include: the prediction system runs m₀ level-0 neural networks NN₀s to perform inference on the m₀ groups of descriptors to obtain the m₀ TD₀s, where an input of any j^{th} neural network NN₀^{j} among the m₀ NN₀s is a j^{th} group of descriptors, and an output thereof is a j^{th} predicted value component TD₀^{j} in the TD₀.

Exemplarily, the method for predicting a target descriptor value of a target object in this embodiment may be implemented by the prediction system based on a pre-trained neural network model, such as a predictive model. The predictive model includes a plurality of levels of neural networks, such as neural networks from level 0 to level F, where a neural network at each level is used to implement inference at the level, for example, a level-0 neural network is used to implement inference at level 0, . . . , and a level-F (Fth level) neural network is used to implement inference at level-F.

Correspondingly, a quantity of level-1 (1st level) neural networks is the same as a quantity of the m₀ groups of descriptors. The prediction system may run each level-0 neural network, so that m₀ level-0 neural networks perform parallel inference on the m₀ groups of descriptors based on a one-to-one correspondence between the neural networks and the descriptor groups to obtain the m₀ TD₀s.

For example, with reference to the foregoing example, the m₀ groups of descriptors include the first group of descriptors and the second group of descriptors. Correspondingly, the level-0 neural networks include neural networks NN₀¹ and NN₀². When the prediction system runs the neural networks NN₀¹ and NN₀², the neural network NN₀¹ performs inference based on the first group of descriptors to obtain a predicted value component TD₀¹, and the neural network NN₀² performs inference based on the first group of descriptors to obtain a predicted value component TD₀².

In other words, inference of the neural network NN₀¹ and inference of the neural network NN₀² are parallel, and there is no mutual interference, so that the inference of the two neural networks can have high reliability, thereby improving accuracy of the m₀ TD₀s.
S403: Perform F levels of inference based on the m₀ TD₀s to obtain a final predicted value TD_{F} of the target descriptor.

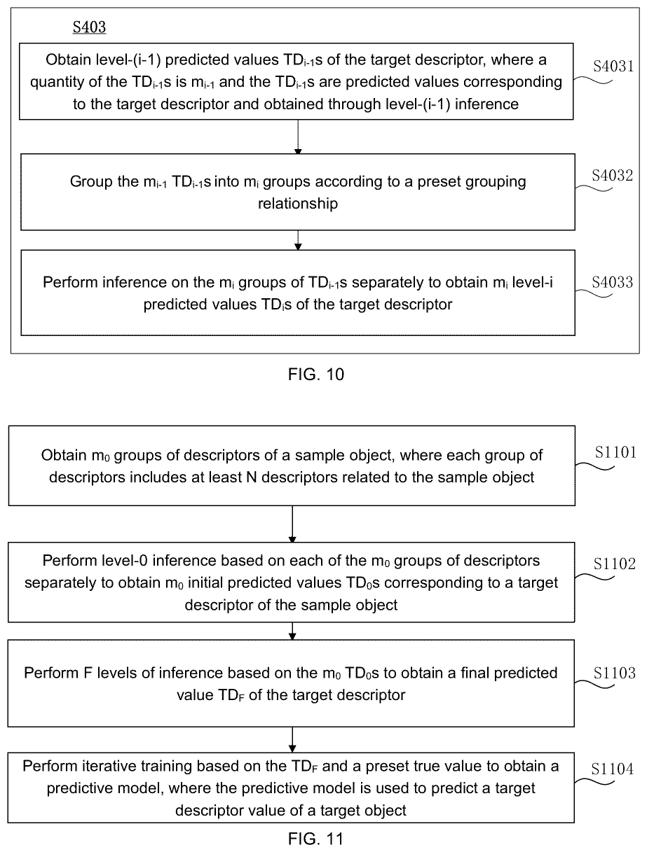

With reference to FIG. 10, it can be learned that level-i (i^{th} level) inference in the F levels of inference includes the following steps.
S4031: Obtain level-(i−1) ((i−1)th) predicted values TDᵢ₋₁s of the target descriptor, where a quantity of the TDᵢ₋₁s is mᵢ₋₁ and the TDᵢ₋₁s are predicted values corresponding to the target descriptor and obtained through level-(i−1) inference.
S4032: Group the mᵢ₋₁ TDᵢ₋₁s into mᵢ groups according to a preset grouping relationship.

The preset grouping relationship is a manner used by the prediction system to group the mᵢ₋₁ TDᵢ₋₁s to obtain the mᵢ groups. The preset grouping relationship is not limited in this embodiment. For example, the preset grouping relationship is a grouping relationship formed by random grouping before training of neural networks or during training of neural networks. In another example, the preset grouping relationship may be a grouping relationship randomly configured by the prediction system. In another example, the preset grouping relationship may be a grouping relationship configured by the prediction system based on mathematical methods such as statistics.

Assuming that the preset grouping relationship is a grouping relationship formed by random grouping before training of neural networks or during training of neural networks by the training system, the predicted grouping relationship may be understood as follows: At a training stage of the target super network, for example, when the training system trains the target super network, for training of a neural network at a level, the training system may randomly group input data of the neural network at the level, thereby obtaining a grouping relationship, and at an application stage of the target super network, for example, when predicting the target descriptor value of the target object based on the target super network, for training of a neural network at a level, grouping of an input of the neural network at the level is the same as grouping of the neural network at the level at the application stage.

For example, with reference to FIG. 8, at the training stage, an input of a first neural network at level 1 (1st level) is an output of a first neural network and an output of a second neural network at level 0 (0th level). Correspondingly, at the application stage, an input of the first neural network at level 1 is also an output of the first neural network and an output of the second neural network at level 0, and so on. The steps are not exhaustively listed herein.
S4033: Perform inference on the mᵢ groups of TDᵢ₋₁s separately to obtain mᵢ level-i predicted values TDᵢs of the target descriptor, where
m₀, N, F, mᵢ₋₁, and mᵢ are all integers greater than or equal to 1, and i meets 1≤i≤F.

In other words, when the prediction system performs level-0 inference, an input of level-0 inference is descriptors, such as the m₀ groups of descriptors in the foregoing example, and in subsequent inference, such as level-1 inference to level-F inference, the prediction system uses a result of previous-level inference as an input of next-level inference, and performs next-level inference based on the result of previous-level inference, until last-level inference is performed to obtain the final predicted value TD_{F}.

For example, with reference to the foregoing analysis, in a case of level-0 inference, the prediction system uses the descriptors as the input of level-0 inference, performs level-0 inference based on the descriptors, and outputs a result of level-0 inference; in a case of level-1 inference, the prediction system uses the result of level-0 inference as an input of level-1 inference, performs level-1 inference based on the result of level-0 inference, and outputs a result of level-1 inference, and so on, until a result of last-level (that is, level-F) inference is obtained, where the result of last-level inference is the final predicted value TD_{F}.

In some embodiments, the third step may include: the prediction system runs mᵢ level-i neural networks NNᵢs to perform inference on the mᵢ groups of TDᵢ₋₁s to obtain the mᵢ TDᵢs, where an input of each of the level-i neural networks is a group of TDᵢ₋₁s among the mᵢ groups of TDᵢ₋₁s, and an output thereof is a corresponding component in a corresponding TDᵢ.

Similarly, in a case that the method for predicting a target descriptor value of a target object in this implementation is performed by the prediction system based on the pre-trained neural network model such as the predictive model, a quantity of level-i neural networks in the predictive model is mᵢ, a quantity of level-i inputs is mᵢ groups, and one group of inputs corresponds to one neural network. Correspondingly, a neural network in a correspondence performs inference on an input to obtain a corresponding component in the TDᵢ.

Exemplarily, the target object is the target material, and it is predicted that the target descriptor value of the target object is electrical conductivity of the target material. In the case of level-0 inference, the prediction system uses descriptors such as thermal conductivity and molecular weight of the target material as the input of level-0 inference, and outputs the m₀ initial predicted values TD₀s; in the case of level-1 inference, the prediction system groups the m₀ initial predicted values TD₀s based on the preset grouping relationship, thereby obtaining the mᵢ groups of initial predicted values TD₀s. and inputs each group of initial predicted values TD₀s into a corresponding first network node, thereby outputting m₁ level-1 predicted values TD₀s; and so on, until the final predicted value TD_{F} is obtained.

As shown in FIG. 8, the m₀ groups of descriptions include a first group of descriptors m₀¹s, a second group of descriptors m₀²s, . . . , an m₀^{th} group of descriptors; level-0 neural networks in the target super network include a first network node NN₀¹, a second network node NN₀², . . . , an m₀^{th} network node; level-1 neural networks in the target super network include a plurality of network nodes such as a first network node NN₁¹, a second network node NN₁², and a third network node NN₁³.

Correspondingly, in level-0 inference of the prediction system, the first group of descriptors m₀¹s is an input of the first network node NN₀¹, and an output is a first predicted value component TD₀¹; the second group of descriptors m₀²s is an input of the second network node NN₀², and an output is a predicted value component TD₀²; and so on. In this way, the m₀ initial predicted values TD₀s are obtained.

In level-1 inference, assuming that the network node is a CNN, the prediction system groups the m₀ initial predicted values TD₀s into m₁ groups based on the preset grouping relationship. Among the m₁ groups, a first group m₁¹ includes the first predicted value component TD₀¹ and the second predicted value component TD₀², a second group m₁¹ includes the second predicted value component TD₀² and a third predicted value component TD₀³, and so on. Details are not exhaustively illustrated herein.

With reference to the foregoing analysis, it can be learned that the target super network includes a plurality of levels of neural networks. In a possible technical solution, each neural network at each level in the target super network has a corresponding weight coefficient, and weight coefficients of different neural networks may be the same or different, so that when confirming an output of a neural network at any level, the prediction system implements the confirmation based on a corresponding weight coefficient of each neural network at the level.

If the weight coefficients of the neural networks are the same, it may be understood that the prediction system obtains predicted values corresponding to the neural networks at each level through prediction based on static adjustment; or if the weight coefficients of the neural networks are different, it may be understood that the prediction system obtains predicted values corresponding to the neural networks at each level through prediction based on dynamic adjustment.

Assuming that the weight coefficients corresponding to the neural networks at each level are the same, for each of neural networks at any level, the prediction system determines a predicted value component of the neural network at the level based on the same weight coefficient. Similarly, assuming that the weight coefficients corresponding to the neural networks at each level are different, for each of neural networks at any level, the prediction system determines a predicted value component of the neural network at the level based on a weight coefficient of the neural network.

The weight coefficient of each neural network may be obtained by calculating a loss function based on training results and pre-marked real results when the training system trains the target super network, and iteratively training a basic network model based on the loss function.

Compared with static adjustment, dynamic adjustment can better fit prediction performance of the neural networks, that is, dynamically adjusted weight coefficients can better represent different prediction performance corresponding to different neural networks. Therefore, the predicted values corresponding to the neural networks at each level and obtained by the prediction system through dynamic adjustment have higher validity and reliability.

Based on the foregoing analysis, it can be learned that the prediction system may predict the target descriptor value of the target object based on the pre-trained predictive model (the target super network described above) to obtain the final predicted value of the target descriptor. The training stage of the predictive model is now exemplarily described with reference to the foregoing example, and parts involving same principles at the training stage and the application stage are not described in this embodiment.

Exemplarily, as shown in FIG. 11, a predictive model training method in the present disclosure may include the following steps.
S1101: Obtain m₀ groups of descriptors of a sample object, where each group of descriptors includes at least N descriptors related to the sample object.
S1102: Perform level-0 inference based on each of the m₀ groups of descriptors separately to obtain m₀ initial predicted values TD₀s corresponding to a target descriptor of the sample object.
S1103: Perform F levels of inference based on the m₀ TD₀s to obtain a final predicted value TD_{F} of the target descriptor.

Level-i inference in the F levels of inference includes the following steps.
Step 1: Obtain level-(i−1) predicted values TDᵢ₋₁s of the target descriptor, where a quantity of the TDᵢ₋₁s is mᵢ₋₁ and the TDᵢ₋₁s are predicted values corresponding to the target descriptor and obtained through level-(i−1) inference.
Step 2: Group the mᵢ₋₁ TDᵢ₋₁s into mᵢ groups according to a preset grouping relationship.
Step 3: Perform inference on the mᵢ groups of TDᵢ₋₁s separately to obtain mᵢ level-i predicted values TDᵢs of the target descriptor, where
m₀, N, F, mᵢ₋₁, and mᵢ are all integers greater than 1, and i meets 1≤i≤F.
S1104: Perform iterative training based on the TD_{F} and a preset true value to obtain a predictive model, where the predictive model is used to predict a target descriptor value of a target object.

This embodiment may be performed by a predictive model training system (hereinafter referred to as a training system). For understanding of the training system, refer to the description of the prediction system in the foregoing example. In addition, with reference to the foregoing analysis, it can be learned that the prediction system and the training system may be the same system or different systems, which is not limited in this embodiment. For an implementation principle of S1101 to S1103, refer to the implementation principle of S401 to S403. Details are not described in this embodiment.

Because a process of training the predictive model by the prediction system is described in this embodiment, relative to an application stage, logic of training the predictive model by the prediction system includes logic of iterative training, that is, a process of performing iterations on a basic network model based on the final predicted value TD_{F} and a pre-labeled true value (that is, the preset true value). The iteration process is not limited in this embodiment.

Exemplarily, the prediction system may calculate a loss function between the final predicted value TD_{F} and the preset true value, and adjust parameters of the basic network model based on the loss function until a preset iteration threshold is reached, or a value of the loss function is less than a preset loss threshold, thereby obtaining the predictive model.

For example, with reference to the foregoing analysis, a neural network at each level in the basic network model is an ANN. In this case, the prediction system may adjust parameters of the ANN (including the weight coefficients described in the foregoing embodiment, and the like) based on the loss function until the value of the loss function is less than the preset loss threshold or the number of iterations reaches the preset iteration threshold. In this case, the network model in this scenario is determined as the predictive model (such as the target super network described in the foregoing embodiment).

In a case that the neural network at each level in the basic network model is a CNN, or that the neural network at each level in the basic network model is a combination of an ANN and a CNN, for iteration logic of the prediction system, refer to the implementation principle in the foregoing example. Details are not described herein.

With reference to the foregoing analysis, it can be learned that at the application stage, the prediction system may determine the mᵢ₋₁ TDᵢ₋₁s as the mᵢ groups based on the preset grouping relationship, and the preset grouping relationship may be determined by the training system at a training stage.

Exemplarily, in a case of first iterative training of the training system, the preset grouping relationship is a grouping relationship formed by random grouping, and in a case of non-first iterative training, the preset grouping relationship is the same as the grouping relationship in the case of first iterative training.

In other words, in the case of first iterative training, the training system may randomly group input information to obtain a preset grouping relationship, and in a case of subsequent iterative training and subsequent application of the predictive model, the preset grouping relationship may be a grouping relationship randomly determined by the training system during the first iterative training.

Based on the foregoing technical conception, the present disclosure further provides a system for predicting a target descriptor value of a target object. The system includes:
at least one storage medium, storing at least one instruction set; and
at least one processor, communicatively connected to the at least one storage medium, where
when the system for predicting a target descriptor value of a target object is running, the at least one processor reads the at least one instruction set, and performs, as instructed by the at least one instruction set, the foregoing method for predicting a target descriptor value of a target object.

Based on the foregoing technical conception, the present disclosure further provides a predictive model training system, including:
at least one storage medium, storing at least one instruction set; and
at least one processor, communicatively connected to the at least one storage medium, where
when the system for predicting a target descriptor value of a target object is running, the at least one processor reads the at least one instruction set, and performs the foregoing predictive model training method as instructed by the at least one instruction set.

Based on the foregoing technical conception, the present disclosure further provides a processor-readable storage medium. The processor-readable storage medium stores a computer program. The computer program is configured to enable a processor to perform the method for predicting a target descriptor value of a target object or the predictive model training method.

Based on the foregoing technical conception, the present disclosure further provides a computer program product, including a computer program. When executed by a processor, the computer program implements the method for predicting a target descriptor value of a target object or the predictive model training method.

Based on the foregoing technical conception, the present disclosure further provides an electronic device, including a processor and a memory communicatively connected to the processor.

The memory stores computer-executable instructions.

The processor executes the computer-executable instructions stored in the memory to implement the method for predicting a target descriptor value of a target object or the predictive model training method.

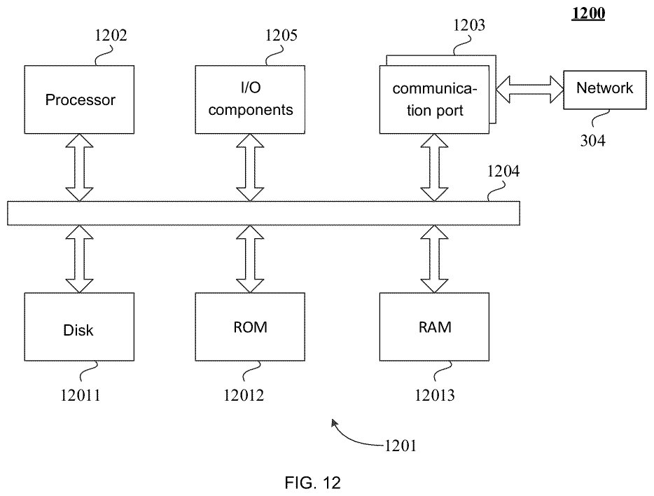

FIG. 12 is a diagram of a hardware structure of an electronic device 1200 according to some exemplary embodiments of the present disclosure. The electronic device 1200 may perform the method for predicting a target descriptor value of a target object or the predictive model training method according to any one of the foregoing embodiments.

Assuming that the method for predicting a target descriptor value of a target object or the predictive model training method in the embodiments of the present disclosure is applied to the application scenario shown in FIG. 3, the electronic device 1200 is described as follows:

In a case that the method for predicting a target descriptor value of a target object or the predictive model training method according to any one of the foregoing embodiments is performed on the client 302, the electronic device 1200 may be the client 302. In a case that the method for predicting a target descriptor value of a target object or the predictive model training method according to any one of the foregoing embodiments is performed on the server 303, the electronic device 1200 may be the server 303. In a case that the method for predicting a target descriptor value of a target object or the predictive model training method according to any one of the foregoing embodiments is partially performed on the client 302 and partially performed on the server 303, the electronic device 1200 may be the client 302 and the server 303.

As shown in FIG. 12, the electronic device 1200 may include at least one storage medium 1201 and at least one processor 1202. In some embodiments, the electronic device 1200 may further include a communication port 1203 and an internal communication bus 1204. In addition, the electronic device 1200 may further include an input/output (I/O) component 1205.

The internal communication bus 1204 may connect different system components, including the storage medium 1201, the processor 1202, and the communication port 1203. The I/O component 1205 supports inputting/outputting between the electronic device 1200 and another component. The communication port 1203 is used for data communication between the electronic device 1200 and the outside world. For example, the communication port 1203 may be used for data communication between the electronic device 1200 and the network 304. The communication port 1203 may be a wired communication port or a wireless communication port.

The storage medium 1201 may include a data storage apparatus. The data storage apparatus may be a non-transitory storage medium, or may be a transitory storage medium. For example, the data storage apparatus may include one or more of a magnetic disk 12011, a read-only storage memory (Read-Only Memory, ROM) 12012, or a random access memory (Random Access Memory, RAM) 12013. The storage medium 1201 further includes at least one instruction set stored in the data storage apparatus. The instruction set is computer program code, where the computer program code may include a program, a routine, an object, a component, a data structure, a process, a module, or the like for performing the method for predicting a target descriptor value of a target object or the predictive model training method provided in this disclosure.

The at least one processor 1202 may be communicatively connected to the at least one storage medium 1201 and the communication port 1203 by using the internal communication bus 1204. The at least one processor 1202 is configured to execute the at least one instruction set. When the electronic device 1200 is running, the at least one processor 1202 reads the at least one instruction set, and performs, as instructed by the at least one instruction set, the method for predicting a target descriptor value of a target object or the predictive model training method provided in this disclosure. The processor 1202 may perform all the steps included in the method for predicting a target descriptor value of a target object or the predictive model training method. The processor 1202 may be in a form of one or more processors. In some embodiments, the processor 1202 may include one or more hardware processors, such as a microcontroller, a microprocessor, a reduced instruction set computer (RISC), an application specific integrated circuit (ASIC), an application specific instruction processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of performing one or more functions, or the like, or any combination thereof. For illustration purposes only, only one processor 1202 in the electronic device 1200 is described in this disclosure. However, it should be noted that the electronic device 1200 in this disclosure may further include a plurality of processors. Therefore, operations and/or method steps disclosed in this disclosure may be performed by one processor in this disclosure, or may be performed jointly by a plurality of processors. For example, if the processor 1202 of the electronic device 1200 in this disclosure performs step A and step B, it should be understood that step A and step B may also be performed jointly or separately by two different processors 1202 (for example, the first processor performs step A, and the second processor performs step B, or the first processor and the second processor jointly perform step A and step B).

A person skilled in the art will understand that the embodiments of this disclosure can be provided as a method, a system, or a computer program product. Therefore, this disclosure can be implemented as a fully hardware embodiment, a fully software embodiment, or an embodiment combining software and hardware aspects. Moreover, this disclosure can be implemented as a computer program product on one or more computer-usable storage media containing computer-usable program code (including but not limited to disk storage, optical storage, etc.).

This disclosure is described with reference to flowcharts and/or block diagrams of methods, devices (systems), and computer program products according to the embodiments of this disclosure. It should be understood that each flow and/or block in the flowcharts and/or block diagrams, and the combinations of flows and/or blocks in the flowcharts and/or block diagrams, can be implemented by computer-executable instructions. These computer-executable instructions can be provided to a processor of a general-purpose computer, a special-purpose computer, an embedded processor, or another programmable data processing device to produce a machine that, when the instructions are executed by a computer or other programmable data processing device, produces a device that performs the functions specified in one or more flows of the flowcharts or one or more blocks of the block diagrams.

These processor-executable instructions may also be stored in a processor-readable memory that can direct a computer or other programmable data processing device to function in a particular way, such that the instructions stored in the processor-readable memory produce an article of manufacture including instruction means that implement the functions specified in one or more flows of the flowcharts or one or more blocks of the block diagrams.

These processor-executable instructions may also be loaded onto a computer or other programmable data processing device to cause a series of operational steps to be performed on the computer or other programmable device to produce a computer-implemented process such that the instructions executed on the computer or other programmable device provide steps for implementing the functions specified in one or more flows of the flowcharts or one or more blocks of the block diagrams.

Apparently, a person skilled in the art can make various modifications and variations to this disclosure without departing from the spirit and scope of the disclosure. Accordingly, if such modifications and variations of this disclosure fall within the scope of the claims of this disclosure and their equivalents, this disclosure is intended to cover these modifications and variations.

What is claimed is:

1. A method for predicting a target descriptor value of a target object, comprising:
obtaining m₀ groups of descriptors of a target object, wherein each group of descriptors includes at least N descriptors related to the target object;
performing level-0 inference based on each of the m₀ groups of descriptors separately to obtain m₀ initial predicted values TD₀s corresponding to a target descriptor of the target object; and
performing F levels of inference based on the m₀ TD₀s to obtain a final predicted value TD_{F} of the target descriptor, wherein
level-i inference in the F levels of inference includes:
obtaining level-(i−1) predicted values TDᵢ₋₁s of the target descriptor, wherein a quantity of the TDᵢ₋₁s is mᵢ₋₁ and the TDᵢ₋₁s are predicted values corresponding to the target descriptor and obtained through level-(i−1) inference,
grouping the mᵢ₋₁ TDᵢ₋₁s into mᵢ groups according to a preset grouping relationship, and
performing inference on the mᵢ groups of TDᵢ₋₁s separately to obtain mᵢ level-i predicted values TDᵢs of the target descriptor, wherein
m₀, N, F, mᵢ₋₁, and mᵢ are all integers greater than or equal to 1, and i meets 1≤i≤F.

2. The method according to claim 1, wherein the obtaining of the m₀ groups of descriptors of the target object includes:
obtaining a K-dimensional description related to the target object, wherein the K-dimensional description comprises K descriptors, wherein K is an integer greater than 1;
performing a dimensionality reduction operation on the K-dimensional description to obtain core descriptors and the descriptor quantity N used to determine the m₀ groups of descriptors; and
generating the m₀ groups of descriptors based on the core descriptors and N, wherein
N refers to a quantity of descriptors among the K descriptors that keeps both accuracy of the dimensionality reduction operation and a quantity of descriptors participating in the dimensionality reduction operation approximately unchanged, and
the core descriptor is a descriptor whose occurrence frequency in participating in the dimensionality reduction operation meets a preset condition among the K descriptors, and the preset condition is that a difference between a minimum occurrence frequency of the core descriptor among the core descriptors and a maximum occurrence frequency of a non-core descriptor is greater than a preset difference threshold.

3. The method according to claim 2, wherein in the m₀ groups of descriptors:
L core descriptors in each group of descriptors are the same; and
N-L non-core descriptors in each group of descriptors are randomly obtained from the K descriptors, and the N-L non-core descriptors in each group of descriptors are not repeated.

4. The method according to claim 1, wherein the performing of the level-0 inference based on each of the m₀ groups of descriptors separately to obtain the m₀ initial predicted values TD₀s corresponding to the target descriptor of the target object includes:
running m₀ level-0 neural networks NN₀s to perform inference on the m₀ groups of descriptors to obtain the m₀ TD₀s, wherein
an input of any j^{th} neural network NN₀^{j} among the m₀ NN₀s is a j^{th} group of descriptors, and an output thereof is a j^{th} predicted value component TD₀^{j} in the TD₀.

5. The method according to claim 4, wherein the performing of the inference on the mᵢ groups of TDᵢ₋₁s separately to obtain the mᵢ level-i predicted values TDᵢs of the target descriptor includes:
running mᵢ level-i neural networks NNᵢs to perform inference on the mᵢ groups of TDᵢ₋₁s to obtain the mᵢ TDᵢs, wherein
an input of each of the level-i neural networks is a group of TDᵢ₋₁s among the mᵢ groups of TDᵢ₋₁s, and an output thereof is a corresponding component in a corresponding TDᵢ.

6. The method according to claim 5, wherein neural networks from level 0 to level F constitute a target super network, each neural network in the target super network is a network node in the target super network, a quantity of network nodes decreases progressively from level 0 to level F, and each neural network is a pre-trained sub-neural network.

7. The method according to claim 6, wherein
each sub-neural network in the target super network is a pre-trained neural network, and the pre-trained neural network is an artificial neural network ANN or a convolutional neural network CNN; or
each sub-neural network in the target super network is a combination of two pre-trained neural networks, and the combination of the two neural networks is a combination of the ANN and the CNN.

8. The method according to claim 1, wherein there is one level-F neural network, with a TD_{F-1} as an input and the final predicted value TD_{F} of the target descriptor as an output.

9. The method according to claim 1, wherein the preset grouping relationship is a grouping relationship formed by random grouping before training of neural networks or during training of neural networks.

10. The method according to claim 1, wherein the target object is one of a target material, a target speech, a target text, and a target image.

11. A system for predicting a target descriptor value of a target object, comprising:
at least one storage medium, storing at least one instruction set for predicting a target descriptor value of a target object; and
at least one processor, communicatively connected to the at least one storage medium, wherein during operation, the at least one processor executes the at least one set of instructions to cause the system to at least:
obtain m₀ groups of descriptors of a target object, wherein each group of descriptors includes at least N descriptors related to the target object,
perform level-0 inference based on each of the m₀ groups of descriptors separately to obtain m₀ initial predicted values TD₀s corresponding to a target descriptor of the target object, and
perform F levels of inference based on the m₀ TD₀s to obtain a final predicted value TD_{F} of the target descriptor, wherein level-i inference in the F levels of inference includes:
obtaining level-(i−1) predicted values TDᵢ₋₁s of the target descriptor, wherein a quantity of the TDᵢ₋₁s is mᵢ₋₁ and the TDᵢ₋₁s are predicted values corresponding to the target descriptor and obtained through level-(i−1) inference,
grouping the mᵢ₋₁ TDᵢ₋₁s into mᵢ groups according to a preset grouping relationship, and
performing inference on the mᵢ groups of TDᵢ₋₁s separately to obtain mᵢ level-i predicted values TDᵢs of the target descriptor, wherein
m₀, N, F, mᵢ₋₁, and mᵢ are all integers greater than or equal to 1, and i meets 1≤i≤F.

12. The system according to claim 11, wherein to obtain the m₀ groups of descriptors of the target object, the at least one processor executes the at least one set of instructions to cause the system to at least:
obtain a K-dimensional description related to the target object, wherein the K-dimensional description comprises K descriptors, wherein K is an integer greater than 1;
perform a dimensionality reduction operation on the K-dimensional description to obtain core descriptors and the descriptor quantity N used to determine the m₀ groups of descriptors; and
generate the m₀ groups of descriptors based on the core descriptors and N, wherein
N refers to a quantity of descriptors among the K descriptors that keeps both accuracy of the dimensionality reduction operation and a quantity of descriptors participating in the dimensionality reduction operation approximately unchanged, and
the core descriptor is a descriptor whose occurrence frequency in participating in the dimensionality reduction operation meets a preset condition among the K descriptors, and the preset condition is that a difference between a minimum occurrence frequency of the core descriptor among the core descriptors and a maximum occurrence frequency of a non-core descriptor is greater than a preset difference threshold.

13. The system according to claim 12, wherein in the m₀ groups of descriptors:
L core descriptors in each group of descriptors are the same; and
N-L non-core descriptors in each group of descriptors are randomly obtained from the K descriptors, and the N-L non-core descriptors in each group of descriptors are not repeated.

14. The system according to claim 11, wherein to perform the level-0 inference based on each of the m₀ groups of descriptors separately to obtain the m₀ initial predicted values TD₀s corresponding to the target descriptor of the target object, the at least one processor executes the at least one set of instructions to cause the system to at least:
run m₀ level-0 neural networks NN₀s to perform inference on the m₀ groups of descriptors to obtain the m₀ TD₀s, wherein
an input of any j^{th} neural network NN₀^{j} among the m₀ NN₀s is a j^{th} group of descriptors, and an output thereof is a j^{th} predicted value component TD₀^{j} in the TD₀.

15. The system according to claim 14, wherein to perform the inference on the mᵢ groups of TDᵢ₋₁s separately to obtain the mᵢ level-i predicted values TDᵢs of the target descriptor, the at least one processor executes the at least one set of instructions to cause the system to at least:
run mᵢ level-i neural networks NNᵢs to perform inference on the mᵢ groups of TDᵢ₋₁s to obtain the mᵢ TDᵢs, wherein
an input of each of the level-i neural networks is a group of TDᵢ₋₁s among the mᵢ groups of TDᵢ₋₁s, and an output thereof is a corresponding component in a corresponding TDᵢ.

16. The system according to claim 15, wherein neural networks from level 0 to level F constitute a target super network, each neural network in the target super network is a network node in the target super network, a quantity of network nodes decreases progressively from level 0 to level F, and each neural network is a pre-trained sub-neural network.

17. The system according to claim 16, wherein
each sub-neural network in the target super network is a pre-trained neural network, and the pre-trained neural network is an artificial neural network ANN or a convolutional neural network CNN; or
each sub-neural network in the target super network is a combination of two pre-trained neural networks, and the combination of the two neural networks is a combination of the ANN and the CNN.

18. The system according to claim 11, wherein there is one level-F neural network, with a TD_{F-1} as an input and the final predicted value TD_{F} of the target descriptor as an output.

19. The system according to claim 11, wherein the preset grouping relationship is a grouping relationship formed by random grouping before training of neural networks or during training of neural networks.

20. The system according to claim 11, wherein the target object is one of a target material, a target speech, a target text, and a target image.
